(19) United States
(12) Patent Application Publication
(10) Pub. No.: US 2025/0050535 A1
(43) Pub. Date: Feb. 13, 2025

(54) METHOD FOR MANUFACTURING SLABS MADE OF STONE OR STONE-LIKE AGGLOMERATE MATERIAL AND HAVING DECORATIONS AND/ OR CHROMATIC EFFECTS, SLAB SO OBTAINED AND WORKING INTERMEDIATE OF A SLAB

(71) Applicant: BRETON S.P.A., Castello di Godego (TV) (IT)

(72) Inventors: Marcello TONCELLI, Bassano del Grappa (VI) (IT); Stefano ZEGGIO, Paese (TV) (IT); Flavio SARTOR, Castelfranco Veneto (TV) (IT)

(21) Appl. No.: 18/723,274

(22) PCT Filed: Dec. 30, 2022
(86) PCT No.: PCT/IB2022/062919

§ 371 Date: Jun. 21, 2024

(30) Foreign Application Priority Data
Jan. 3, 2022 (IT) 102022000000026

(51) Int. Cl. B28B 11/00; B28B 11/04; B41M 5/00; B41M 7/00; B44C 5/04

(52) U.S. Cl. CPC B28B 11/001; B28B 11/048; B41M 5/007; B41M 7/009; B44C 5/0438

(57) ABSTRACT

A method for manufacturing slabs made of stone or stone-like agglomerate material and having decorations and/or chromatic effects, including steps of machining at least one surface of the slab by means of sizing and/or polishing, applying a dispersed ink containing pigments on the at least one machined surface, drying the dispersed ink, penetration, by means of diffusion, of the pigments of the dispersed ink into the slab following a change in state of the pigments, to realize the decorations and/or the chromatic effects, cooling the slab, removing the excess or residual dispersed ink from the at least one surface of the slab, and applying a layer of functional compound on the at least one surface of the slab. Also relating to a slab of stone or stone-like agglomerate material including at least one surface with decorations and/or chromatic effects and a working intermediate for manufacture thereof.

The present invention relates to the technical field for the production of articles of stone or stone-like agglomerate material and relates in particular to a method for manufacturing slabs having decorations and/or chromatic effects on at least one surface. The invention also relates to a slab of stone or stone-like agglomerate material having decorations and/or chromatic effects on at least one of the surfaces and a working intermediate of the slab.

In the technical field for the production of articles and slabs made of stone or stone-like agglomerate material, the agglomerate is obtained preferably, although not exclusively, by means of vibration with simultaneous vacuum compression (vacuum vibro-compression) and hardening of a base mix.

The mix contains mainly a binder and aggregates formed by granules and/or powders of stone or stone-like material.

In particular, the aggregates generally consist of natural minerals which may be of a siliceous nature, such as quartz, granite, porphyry, basalt, quartzites, siliceous sands, or of a calcareous nature, such as marble, dolomite, coloured stones, etc. Alternatively, the aggregates may consist of synthesized minerals.

The granules and powders may have a varied particle size, depending on the aesthetic appearance and the physical/mechanical properties which are to be obtained in the finished slabs.

Alternatively or in addition, the mix may also contain expanded granules or powders, such as expanded glass or expanded clay.

Furthermore, the binder is preferably of an organic type and consists of a hardening resin chosen from the group comprising polyester resins, acrylic resins, epoxy resins, polyurethane resins, but also resins of natural and plant origin.

As an alternative to the organic binding resin a cementitious binder may be used.

The mix may also contain fillers, further binders, additives and dyes. In particular, the filling agents, or mineral fillers, are materials used in combination with the resin in order to form the so-called binding paste.

The fillers generally consist of stone, natural or synthesized materials of various kinds, which are finely ground, such as ventilated silica or ventilated feldspar for the agglomerates formed with siliceous aggregates, and calcium carbonate or aluminium hydroxide for the agglomerates formed with calcareous aggregates.

The slabs of agglomerate material, which are made as indicated above, may also undergo a step involving the application or printing of an ink containing pigments, preferably a dispersed and/or sublimation ink, on at least one of the surfaces in order to form decorations and/or chromatic effects.

In the context of the present description, the expression “dispersed ink” is understood as meaning an ink in which the pigments are intended to undergo a transition from the solid state to the liquid/gaseous state owing to the action of a heat source and/or application of a pressure.

Furthermore, in the context of the present description, the expression “sublimation ink” is understood as meaning an ink in which the pigments are intended to undergo sublimation, passing from the solid state to the gaseous state as a result of the action of a heat source and/or application of a pressure.

In both aforementioned types of ink, the pigments are dispersed in a preferably aqueous solution and the change in state favours the penetration, by means of diffusion, of the pigments into the surface layer of the slab.

In particular, following the change in state, the pigments in the inks penetrate by means of diffusion into the binding resin of the mix, namely the organic component of the mix.

The sublimation ink constitutes a specific type of dispersed ink; therefore, in the continuation of the present description and where not otherwise indicated, reference will be made for the sake of convenience only to dispersed ink.

The printing by means of dispersed ink is widespread, not only in the technical field of the present invention, but also in the field of fabric (polyester and nylon) printing, in the sector of aluminium frames, in the visual communications field, in the interior decoration field and in the gifts and souvenirs field.

In the technical field of the present invention, in order to apply the dispersed ink onto the slab or onto the base mix in an effective manner and with an attractive aesthetic effect, the aggregates and/or the slab must have at least the following characteristics:
a light pigmentation of the aggregates, preferably white or slightly coloured with light shades;
a small particle size of the granules or the powders.

Furthermore, the application of the dispersed or sublimation ink onto at least one surface of the slab may be performed in two different ways, namely:
using a sheet having, previously printed thereon, the decoration with the ink to be subsequently applied onto the surface of the slab; or
directly applying the ink onto the surface of the slab or onto the base mix.

The first application method is used preferably with sublimation ink and involves essentially the following steps:
printing the decoration with sublimation ink on a sheet, also called sublimation sheet;
depositing the sublimation sheet on a visible surface of the slab which has been machined (smoothed, polished, sized, etc.);
inserting the slab and the sublimation sheet into a hot press in order to perform the sublimation of the sublimation ink and transfer of the decoration from the sheet to the material of the slab;
cooling of the slab to room temperature.

This operating mode, although widely used, is not without a number of drawbacks.

A first drawback of this solution lies in the fact that the process requires the simultaneous checking of the various process parameters, thus making the process particularly long and complex.

Another drawback consists in the fact that the decorations which can be obtained on the slab following sublimation of the ink are often blurred and not well-defined.

The second operating mode instead involves the formation of the decoration and/or the chromatic effect directly on the surface of the slab or on the base mix by applying the dispersion or sublimation ink for example by means of digital inkjet plotters or printers.

Examples of this second operating mode are known, for example, from the patent documents US2020/0262101 and WO2021/053596.

US2020/0262101 discloses a method for manufacturing articles and slabs made of engineered stone and having patterns printed on at least one surface. The method comprises the following steps:
providing a base mix and dispensing, as required, a colouring agent in the mix by means of an anthropomorphic robot;
vacuum vibro-compression of the mix;
hardening of the mix;
machining of the article.

The method also involves a step of application of an ink onto at least one surface of the article or the slab in order to form the patterns, this application step being performed alternatively:
before vacuum vibro-compression of the mix;
between vibro-compression and hardening of the mix;
between hardening of the mix and machining of the article.

This latter embodiment also envisages a step involving hardening of the decoration formed with the ink, which may be performed at the same time as hardening of the mix or at a different time.

Therefore, the application of the ink may be carried out on the fresh mix to be compacted or on the compacted mix or on the article following hardening of the mix.

The inks used may be of the organic or inorganic type or a combination thereof and may be chosen from the group comprising water-based inks, solvent-based inks and sublimation inks.

Furthermore, the method according to US2020/0262101 may comprise a further step of applying a protective coating onto the article or onto the slab in order to improve the resistance to wear and scratches and provide the article or slab with anti-microbial properties.

The protective coating may be formed by a filler, for example corundum, silver or titanium oxide, and by a hardening resin, for example an epoxy resin or an acrylic resin.

WO2021/053596 discloses a plant for manufacturing slabs made of agglomerate material from a mix of the type indicated above.

The plant comprises both means for applying a mixture to the mix in order to form veining and decoration means for applying a dispersed ink on at least one surface of the slabs.

In particular, the application of the dispersed ink by means of the decoration means is carried out on the compacted mix, i.e. before hardening of the mix.

The decoration means consist of digital ink printer provided with a plurality of movable heads and designed to allow penetration of the ink into the compacted mix over a thickness of between 3 cm and 4 cm.

After performing the compaction step, in a manner similar to that described above for US2020/0262101, the mix is preheated to a temperature of between 30° C. and 60° C. in order to favour the penetration of the dispersed ink in the mix which will be subsequently deposited.

Hardening of the mix is performed by means of heating to a temperature of between 100° C. and 150° C.

These latter technical solutions are also not without certain drawbacks.

A first drawback consists in the fact that the subsequent machining operations carried out on the surface of the article or the slab onto which the ink has been applied tend to remove the superficial layers of material and therefore part of the decoration previously applied.

A further drawback consists in the fact that the protective coating, where provided, also tends to be at least partially removed following machining of the article or the slab.

Therefore, this drawback results in less resistance of the article or slab to wear and scratches.

Another drawback consists in the fact that the dispersed ink applied onto the slab may be removed at least partially by means of particularly aggressive solvents.

The main object of the present invention is therefore to provide a method for manufacturing slabs of stone or stone-like agglomerate material having decorations and/or chromatic effects, a slab thus obtained and a working intermediate of a slab, which allow the aforementioned drawbacks to be overcome.

One particular task of the present invention is to provide a method of the type described above which allows the manufacture of slabs in which the decorations and the chromatic effects are well-defined, pronounced and clearly visible.

Another task of the present invention is to provide a method of the type described above which allows the manufacture of slabs with decorations and/or chromatic effects which last over time.

A further task of the present invention is to provide a method of the type described above which reduces significantly the risk of removal or erasure of the decorations and/or the chromatic effects from the surface of the slab on which they are formed.

Another task of the present invention is to provide a method of the type described above which allows the manufacture of slabs with a high resistance to wear, scratches and solvents.

A further task of the present invention is to provide a method of the type described above, which is able to allow the manufacture of slabs suitable for use when laying flooring or mounting external cladding and kitchen worktops.

Another object of the present invention is to provide a slab made of stone or stone-like agglomerate material and having decorations and/or chromatic effects which are well-defined and pronounced.

The object and the main tasks described above are achieved with a method for manufacturing slabs of stone or stone-like agglomerate material having decorations and/or chromatic effects in accordance with Claim 1, with a slab having decorations and/or chromatic effects on at least one surface in accordance with Claim 18, and with a working intermediate of the slab in accordance with Claim 19.

The present description, provided solely by way of a non-limiting illustration of the scope of protection of the invention, relates to a method for manufacturing slabs of stone or stone-like agglomerate material having decorations and/or chromatic effects formed on at least one of the surfaces.

Conveniently, the slab is obtained from a mix comprising a binding resin and aggregates formed by granules and/or powders of stone or stone-like material, as described further below.

The decorations and the chromatic effects are preferably realized by means of a dispersed ink or an ink in which the pigments are intended to undergo a change in state from solid to liquid/gaseous owing to the action of a heat source and/or the application of a predetermined pressure.

Such a dispersed ink is particularly resistant both to chemical agents and to UV rays.

The decorations and the chromatic effects may also be realized by means of a sublimation ink, namely an ink in which the pigments are intended to undergo sublimation, changing from the solid state to the gaseous state owing to the action of a heat source and/or the application of a predetermined pressure.

The pigments of the dispersed ink penetrate by means of diffusion into the slab, in particular in the zones or portions of the slab where the binding resin is present, following the change in state, more specifically sublimation in the case of a sublimation ink.

The method comprises mainly the following steps:
machining at least one surface of the slab by means of sizing and/or smoothing and/or polishing,
applying a dispersed ink containing pigments in a dispersion on the at least one machined surface of the slab;
drying the dispersed ink;
penetration, by means of diffusion, of the pigments of the dispersed ink into the slab following the change in state of the pigments, so as to realize the decorations and/or the chromatic effects;
cooling the slab;
removing the excess or residual dispersed ink from the at least one surface of the slab;
applying a layer of functional compound on the at least one surface of the slab.

Preferably, before machining the surface of the slab, there is a step for producing the slab comprising vacuum vibro-compression and hardening of the mix previously distributed in a suitable support, in accordance with the method also known as Bretonstone®.

In this connection, the material of the granules and powders which form the aggregates of the mix is preferably quartz and/or a synthesized mineral containing calcium silicate crystals.

Furthermore, the aggregates of granules and powders have a particle size preferably of between 0.1 mm and 0.3 mm and volume content equal to about 75% of the volume of the slab.

The granules and the powders, and consequently the aggregates, thus made, have a pigmentation which is preferably white-based or is slightly coloured with light shades.

The slab of agglomerate material made from the aforementioned aggregates also has a pigmentation which is preferably white-based or is slightly coloured with light shades.

Owing to these particular characteristics of the aggregates of granules and powders and consequently of the slab of agglomerate material it is possible to achieve the clear, pronounced and well-defined effect of the decorations.

The binding resin of the mix is of the type described above with reference to the prior art and for this reason will not be further described in the present description.

The slab may also have veining formed by means of distribution of a colouring agent in the mix which is to undergo vibro-compression and hardening, provided that the veining also has a pigmentation which is white-based or is slightly coloured with light shades.

The operations of sizing and/or polishing and/or smoothing are performed on the hardened slab using machines, devices and tools of the known type, not described further in the present description.

In a manner known per, the step of applying the dispersed ink is performed using digital inkjet plotters or printers and may be carried on specific portions of the surface of the slab or over the entire surface of the slab to be decorated, depending on the type of decoration which is to be provided.

The dispersed ink consists preferably of a dispersion of pigments in a solution, which is preferably aqueous, and is applied on at least one surface of the slab in liquid form.

The step of applying the dispersed ink may be preceded by a step of applying and drying a primer.

Preferably, the primer consists of a solution or dispersion-preferably aqueous-of organic and/or inorganic compounds which are compatible with the process involving direct application of the dispersed ink onto the slab.

The primer has the function of promoting adhesion of the dispersed ink and preventing the uncontrolled diffusion thereof over the surface of the slab during the penetration step, thus preventing a reduced chromatic yield and definition of the decoration.

Conveniently, the step of drying the dispersed ink is performed after application of the dispersed ink and before penetration by means of diffusion; said drying step may be performed in an oven at a temperature of between 85° C. and 95° C. and for a duration of between 2 and 20 minutes.

Alternatively, the drying step may be performed in a hot-air oven at a temperature close to 110°-120° C. and for a time of about 60 minutes.

This latter operating mode allows the slabs to be heated to a temperature close to 100° C.

The drying step carried out using the methods described above is able to eliminate the volatile compounds from the—preferably aqueous—solution of dispersed ink applied onto the at least one surface of the slab.

In this way, the dried dispersed ink forms a kind of film on the surface of the slab to be decorated; this film has a function similar to the function of the sublimation sheet used in the conventional methods.

As mentioned, during penetration by means of diffusion, the pigments of dispersed ink are intended to undergo a change in state from solid to liquid/gaseous.

In the embodiment which envisages the use of a sublimation ink, the diffusion penetration step is performed by means of sublimation of the pigments of the sublimation ink, namely by means of the change from the solid to gaseous state.

In accordance with a particular aspect and differently from the methods known from the prior art, in the method according to the present invention the steps of application, drying and penetration by means of diffusion are performed after the machining of the at least one surface of the slab and without the aid of sublimation sheets.

Therefore, in the method of the present invention, the pigment drying and penetration steps are not carried out on the mix which is to be compacted or hardened, namely before machining of the surface of the slab on which the dispersed ink has been applied. In this way it is possible to avoid or limit the removal of the decoration and/or the chromatic effects during machining of the slab.

The step involving penetration, by means of diffusion, of the dried sublimation and/or dispersed ink is performed in an oven, preferably a hot-air oven.

If the drying step is performed at a temperature of between 85° C. and 95° C. as described above, the hot-air oven for performing the ink diffusion penetration step is kept at a temperature of between 150° C. and 200° C. for a time of between 5 and 30 minutes.

Alternatively, if the drying step is performed at a temperature close to 110° C.-120° C. as described above, the hot-air oven for performing the ink diffusion penetration step is kept at a temperature close to 200° C. for a time of between 10 and 15 minutes.

The execution of the drying step at a temperature close to 110°-120° C., which allows the slabs to be heated to a temperature close to 100° C. at the end of the drying step, allows small-size ovens to be used in order to carry out the diffusion penetration step.

The step of cooling the slab is performed after step of penetration by means of diffusion of the dispersed ink pigments and must be carried out in such a way as to avoid thermal shocks or twisting of the slab.

For this reason, cooling is performed preferably at room temperature and lasts at least 60 minutes.

The aforementioned measures help ensure the penetration of the ink pigments in the superficial layers of resin of the slab or in the zones of the surface of the slab where the resin is present following the change in state, in particular following sublimation.

Advantageously, the step of removal of the excess dispersed ink is performed after the cooling step and by brushing with abrasive tools the at least one surface of the slab. In order to avoid scuffing or abrasion of the material from the surface of the slab, the abrasive tools must have a hardness less than the hardness of the aggregates indicated above, in particular less than the hardness of the quartz and/or the synthetic material containing the calcium silicate crystals.

However, in order to remove the excess or residual dispersed ink effectively, the hardness of the abrasive tools must be greater than the hardness of the components of the dispersed ink.

Conveniently, the step of application of the layer of functional compound on the at least one surface of the slab is performed after the step for penetration of the pigments of dispersed ink, namely after the step of sublimation of the sublimation ink.

In particular, the step of application of the functional compound is performed after both the penetration and cooling step and the step of removal of the excess or residual dispersed ink.

Preferably, the functional compound is transparent and consists of a silazane solution in a solvent; silazane is an organo-metallic compound consisting of a hydride of silicon and nitrogen having a linear or branched chain of silicon, nitrogen or carbon atoms joined by covalent bonds.

The functional compound of the type indicated above, after being applied onto the surface of the slab on which the decoration has been formed, is allowed to dry and harden so as to form a layer having a thickness of a few microns; said layer contains nanoparticles of quartz bonded covalently to the functional groups on the surface of the slab.

In particular, in the slab according to the present invention obtained from the mix described above, the solution of silazane is stably bonded both to the aggregates, in particular to the granules of silica and calcium silicate, and to the organic component of the resin and the ink.

Generally the silazane solutions are used to increase the corrosion resistance of the materials, for example as an anti-fouling agent in boats, on aircraft windscreens in order to increase the abrasion resistance, on train carriages in order to facilitate the removal of graffiti and in the past also for the manufacture of cladding tiles for space shuttles.

In the technical field of the present invention the silazane solution allows the slabs to be made more resistance to wear, trampling, chemical agents, solvents, scratches and adverse weather.

Therefore the functional compound formed by the silazane solution has a protective function, namely it acts as a protective compound, allowing the use of the slab obtained with the method according to the present invention for the laying of flooring or mounting of external cladding and kitchen worktops or other products which are normally subject to wear.

In addition to the protective function, the silazane solution also helps confer a greater shininess to the surface of the slab onto which it is applied.

The layer of functional compound may also be applied following laying/mounting of the slab and several times on the decorated surface of the slab if it is required to restore the intact condition and the aesthetic appearance of the slab.

Furthermore, the method may comprise, before application of the layer of functional compound, a step of polishing the surface of the slab onto which the functional compound will be applied, using fine-grain polishing tools.

The latter step allows removal of the superficial layer from the surface of the slab, at least over a thickness of a few microns, and becomes necessary because heating of the slab to 200° C. may deteriorate the superficial state of the slab, with a reduction in the shininess thereof.

Furthermore, the present invention relates to:
a slab of stone or stone-like agglomerate material having decorations and/or chromatic effects realized with dispersed or sublimation ink on at least one surface, the slab being obtained by means of the method described above.
a working intermediate for manufacturing a slab of stone or stone-like agglomerated material having at least one surface with decorations and/or chromatic effects realized with dispersed or sublimation ink.

In particular, the working intermediate comprises a layer of dried dispersed ink on at least one surface; in fact, the working intermediate is obtained following the drying step of the method described above, before the ink penetrates into the layer by means of change in state.

From the above description it is now clear how the method for manufacturing slabs, the slab and the working intermediate according to the present invention are able to achieve advantageously the predefined objects.

In particular, the application and the penetration of the dispersed ink realized following the machining of the slab and the application of the functional compound allow a finished product to be obtained where the decorations and/or the chromatic effects are clear and well-defined and have the following special features:
abrasion resistance;
resistance to solvents and chemical agents;
mechanical properties which are comparable to those of the slabs known from the prior art.

Furthermore, the execution of the steps described above after the dispersed ink application step favours the penetration of the ink pigments in the superficial layers or in the zones of the surface of the slab where the resin is present, resulting in clear and well-defined decorations and chromatic effects.

Finally, as a result of the characteristic feature involving a pigmentation of the aggregates which is white-based or is slightly coloured with light shades, it is possible to obtain a clear, pronounced and well-defined aesthetic effect.

In accordance with the teachings of the invention it is therefore possible to obtain slabs having a greater shininess with an attractive and uniform aesthetic effect over the whole surface, since the light spreads and is reflected more efficiently.

Obviously, the above description of embodiments applying the innovative principles of the present invention is provided by way of example of these innovative principles and must therefore not be regarded as limiting the scope of the rights claimed herein.

1. A method for manufacturing slabs made of stone or stone-like agglomerate material and having decorations and/or chromatic effects, the method comprising at least the following steps:
machining at least one surface of the slab, by means of sizing and/or smoothing and/or polishing;
applying a dispersed ink containing pigments on said at least one machined surface;
drying said dispersed ink;
penetration, by means of diffusion, of the pigments of the dispersed ink into the slab by means of the change in state of the pigments so as to form the decorations and/or the chromatic effects;
cooling the slab;
removing the excess or residual dispersed ink from the at least one surface of the slab; and
applying a layer of functional compound on said at least one surface of the slab.

2. The method according to claim 1, characterized in that, during said step of penetration by means of diffusion, the pigments of said dispersed ink undergo a change in state from solid to liquid/gaseous.

3. The method according to claim 1, characterized in that said dispersed ink is a sublimation ink, said step of penetration by means of diffusion being performed by means of sublimation of the pigments of said sublimation ink.

4. The method according to claim 1, characterized in that said drying step is performed in an oven at a temperature of between 85° C. and 95° C. for a time of between 2 and 20 minutes.

5. The method according to claim 1, characterized in that said step of penetration by means of diffusion is performed in an oven at a temperature of between 150° C. and 200° C. for a time of between 5 and 30 minutes.

6. The method according to claim 1, characterized in that said drying step is performed in an oven at a temperature of between 110° C. and 120° C. for a time close to 60 minutes.

7. The method according to claim 6, characterized in that said step of penetration by means of diffusion is performed in an oven at a temperature of close to 200° C. for a time of between 10 and 15 minutes.

8. The method according to claim 1, characterized in that said cooling step lasts at least 60 minutes.

9. The method according to claim 1, further comprising, before the step of application of the layer of functional compound, a step of polishing said surface of the slab using fine-grain tools.

10. The method according to claim 1, characterized in that said step of applying said dispersed ink on said at least one surface is preceded by a step of applying and drying a primer.

11. The method according to claim 10, characterized in that said primer consists of a solution or dispersion, of organic and/or inorganic compounds compatible with the process involving direct application of the dispersed ink onto the slab.

12. The method according to claim 1, characterized in that said step of removing the excess or residual dispersed ink from the at least one surface of the slab is performed by means of brushing using abrasive tools.

13. The method according to claim 1, characterized in that said functional compound is transparent and consists of a silazane solution.

14. The method according to claim 1, further comprising, before said step of machining the surface of the slab, a step of manufacturing the slab which involves vacuum vibro-compression and hardening of a mix, said mix comprising a binding resin and aggregates formed by granules and/or powders of stone or stone-like material.

15. The method according to claim 14, characterized in that the material of said granules and powders is quartz and/or a synthesized mineral containing calcium silicate crystals.

16. The method according to claim 14, characterized in that the aggregates of granules and/or powders of stone or stone-like materials have a particle size of between 0.1 mm and 0.3 mm.

17. The method according to claim 1, characterized in that the aggregates formed by granules and/or powders have a pigmentation which is white-based or is slightly coloured with light shades.

18. A slab of stone or stone-like agglomerate material comprising at least one surface with decorations and/or chromatic effects formed with a dispersed ink containing pigments, made by means of at least one step involving machining at least one surface by means of sizing and/or smoothing and/or polishing, a step of applying the dispersed ink onto said at least one machined surface, a step of drying said dispersed ink, a step of penetration, by means of diffusion, of the pigments of the dispersed ink into the slab by means of change of state of the pigments, a step of cooling the slab, a step of removing the excess or residual dispersed ink from the at least one surface of the slab and a step of applying a layer of functional compound on the at least one surface of the slab.

19. A working intermediate for manufacturing a slab of stone or stone-like agglomerate material comprising at least one surface with decorations and/or chromatic effects realized with a dispersed ink containing pigments, said working intermediate comprising a layer of dried dispersed ink on said at least one surface.

20. The method according to claim 11, characterized in that said primer is aqueous.

21. The method according to claim 15, characterized in that the aggregates of granules and/or powders of stone or stone-like materials have a particle size of between 0.1 mm and 0.3 mm
